(19) United States
(12) Patent Application Publication
(10) Pub. No.: US 2015/0007663 A1
(43) Pub. Date: Jan. 8, 2015

(54) DETECTION DEVICE FOR METAL STRIPS OR PLATES

(71) Applicant: SMS Siemag Aktiengesellschaft, Düsseldorf (DE)

(72) Inventor: Frederik Grosse Lordemann, Dusseldorf (DE)

(73) Assignee: SMS Siemag Aktiengesellschaft, Düsseldorf (DE)

(21) Appl. No.: 14/380,408

(22) PCT Filed: Feb. 6, 2013
(86) PCT No.: PCT/EP2013/052265

§ 371 Date: Aug. 22, 2014

(30) Foreign Application Priority Data
Feb. 22, 2012 (DE) 10 2012 202 692.4

(51) Int. Cl. G01D 21/00; B65G 13/02

(52) U.S. Cl. CPC G01D 21/00; B65G 13/02
USPC 73/700; 198/502.3

(57) ABSTRACT

A device for detecting the presence of rolling or cast stock, more particularly a metal strip or plate, in a casting, rolling or other strip processing facility, wherein the device includes a detection device for detecting a fluid jet which indicates the presence of the rolling or cast stock. The detection device in turn has an air-filled cavity, which has a tubular opening, and a pressure sensor for detecting an air pressure change in the cavity when the fluid jet hits the tubular opening. A corresponding method for determining the position of rolling or cast stock, more particularly a metal strip or plate, which moves through a casting, rolling or other strip processing facility.

### AREA OF THE INVENTION

The invention pertains to a device for detecting the presence of rolled or cast stock, especially a metal strip or plate, in a position in a casting, rolling, or other type of strip-processing facility. In other words, the invention pertains to a device for detecting rolled or cast stock moving through a casting, rolling, or other type of strip-processing facility. Such a facilities can also be understood to consist of straightening machines or cooling lines

### PRIOR ART

Especially in plate cooling units for large plates, synchronization points (“sync points”) are used within the installation as a means of keeping track of the material. These points have consisted up to now of, for example, a water nozzle underneath the plate or roller table and a type of cup, which is raised by the jet of water. The raised position is detected by a limit switch. When a plate is being transported through the machine, the water jet is interrupted by the plate. As a result, the cup falls under the force of gravity. This position is also detected by a limit switch. By means of this arrangement, the time at which the plate passes the sync point can be determined.

The disadvantage of this arrangement, however, is the complicated structure of the cup assembly with its mechanical guides and limit switches. The cup is guided by a rod passing through a pipe. This guidance is subject to a certain amount of wear as a result of the high thermal and abrasive loads. The task of keeping the device aligned properly on the machine is also complicated. The nozzle underneath the roller table, furthermore, must be directed precisely at the center of the cup, so that the transverse forces to which the cup is subjected are as small as possible. In addition, the mechanics consist of many individual parts, which are fabricated out of expensive stainless steel with machined surfaces. Because of the thermal encapsulation, a large amount of space is also taken up, which means that there are usually limitations on the positioning of the measurement apparatus.

Other known devices comprise mechanical rollers, which are placed on the moving strip. The disadvantage of rollers is that they comprise a certain. overrun or can slip across the strip and thus deliver imprecise or false information on the presence of a strip. In addition, the rollers can be contaminated by dust or slag, for example, as a result of which their freedom of rotation is impaired, and they suffer wear. In the worst case, the rollers can become blocked. In addition, the rollers must be configured with means for adjusting their height, because they must be adaptable to strip and plate of different thicknesses.

Another device is known from JP 60196223 A, in which a water jet is directed onto a plate connected to a piston. When the water jet strikes the plate, the piston moves into a tube filled with oil. At one end of the tube, a plunger is arranged, which, when moved, triggers a signal, which signifies that no rolled stock is present. The disadvantage of this arrangement is the use of a plurality of individual parts together with a plurality of mechanical friction and wear points. Because several components, i.e., the plunger and the piston, are required to move, furthermore, the function of the described device is indirect and relatively slow.

Another device according to the prior art is known from JP 61200414 A. in this device, a water jet is detected by way of a dish attached to a rotatable axis. Rotation of the axis caused by the jet leads to a change in the intensity of the light detected by a light-sensitive sensor. This device, too, comprises a large number of mechanical moving parts, which are subject to wear. In cases where light intensity is measured, furthermore, it is disadvantageous that the conditions are often very harsh in casting or rolling installations. Thus, for example, dust or slag spatters can contaminate a light-sensitive sensor and render it unusable or even destroy it. The path along which the light of a laser travels to the light-sensitive sensor can also be disturbed by external influences, so that false position information is acquired concerning the moving rolled or cast stock.

In summary, the goal of the present invention is to provide a more highly developed device for detecting the presence or position of a metal strip in a casting, rolling, or other type of strip-processing facility.

Another goal of the invention is to overcome at least one of the disadvantages cited above.

### DISCLOSURE OF THE INVENTION

The technical problem described above is solved by the device for detecting the presence or position of rolled or cast stock, especially of a metal strip or plate, in a casting, rolling, or other type of strip-processing facility according to claim 1, wherein the device comprises a detection unit for detecting a fluid jet indicative of the presence of the rolled. or cast stock, and the detection unit in turn comprises an air-filled cavity, which comprises a preferably tubular opening or a preferably tubular inlet. According to the invention, the detection device also comprises a pressure sensor for detecting a change in the air pressure in the cavity as a function of the arrival of the fluid jet at the tubular opening.

As a result of the arrival of the jet at, or the guidance of the jet into, the preferably tubular opening, a pulse is transmitted to the air located in the cavity or hollow body. This pulse transmission leads to a change in the air pressure in the cavity, which a pressure sensor can register,

When the fluid jet strikes the opening, the pressure in the cavity increases. As soon as the jet stops striking the opening, the pressure in the cavity decreases correspondingly,

In other words, the device serves to detect moving rolled or cast stock and represents preferably a control or synchronization point (which is arranged in the direction along which the rolled or cast stock travels through the facility).

A device conceived in this fashion offers the advantage that there is no longer any need for moving mechanical parts. There is almost no possibility that dust or slag spatters can exert a significant effect. The device has only a small number of parts, which reduces costs. Because the measurement is made by a pressure sensor, furthermore, very short data acquisition times of less than 0.1 s can be achieved (the time between the arrival of the jet at the opening and detection by the pressure sensor). In addition, the device can detect both the leading edge of a piece of moving rolled or cast stock and also the trailing edge. Finally, the device according to the invention takes up only a small amount of space.

According to a preferred embodiment of the device, the detection device comprises a funnel-shaped component for conducting the fluid jet into the opening, this component being mounted on the preferably tubular opening outside the cavity. Thanks to this feature, the fluid jet does not have to be aimed with high precision at the detection device, which simplifies the installation, startup, and operation of the device. The funnel-shaped component preferably has an outside diameter of less than 20 cm, and more preferably of less than 10 cm.

According to another preferred embodiment of the device, the cavity comprises at least one tubular section, which extends over at least 1 m and preferably over more than 2 m. Such a section can be used preferably to set up the pressure sensor at a distance of more than 2 m from the moving rolled or cast stock. As a result, the sensor can be protected even more effectively and interferes even less with the operation of the facility. The sensor can also be exchanged or connected more easily.

According to another preferred embodiment of the device, the cavity is formed essentially by a tube. The inside diameter of the tube can preferably be on the same order as that of the jet which is used; it can therefore be, for example, 0.5-5 times the diameter of the jet. Other tube diameters can also be used, however. The cross-sectional shapes of the tube or of the opening can also be selected as desired and are not limited to round shapes.

According to another preferred embodiment of the device, the pressure sensor is arranged at one end of the tube, namely, at the end opposite the opening

According to another preferred embodiment of the device, the pressure sensor is configured as a pressure switch. It is in particular not necessary to determine the absolute pressure. A pressure switch which can detect only a change in pressure is also sufficient. The appropriate switch depends on the shape of the tube and on the jet being used (volume flow rate, pressure, etc.) It can be selected by the person skilled in the art.

According to a preferred embodiment of the device, the device also comprises means for producing a fluid jet directed at the preferably tubular opening of the detection device.

According to another preferred embodiment of the device, the means for producing the fluid jet and the detection device are arranged on opposite sides of the path along which the rolled or cast stock travels (through the casting, rolling, or other strip-processing facility) in such a way that, when the rolled or cast stock interrupts the fluid jet produced by the means for fluid jet production, the air pressure in the cavity decreases. In this way, the pressure sensor or pickup can detect the presence of the strip.

The present invention also comprises a facility for the casting, rolling, straightening, or conveying of rolled or cast stock, especially of metal strips or plates, wherein the facility comprises a device according to the invention according to one of the above embodiments and a device for transporting the rolled or cast stock along a path of movement (through the facility).

According to another preferred embodiment, the rolled or cast stock can be conveyed through the facility in essentially a horizontal direction.

According to another preferred embodiment, the detection device is arranged above the path of movement of the rolled or cast stock, and the means for producing the directed fluid jet is arranged underneath the path of movement of the rolled or cast stock. By means of such a measure, the undesirable situation is avoided in which, for example, liquids drip or run or solids fall into the opening of the cavity, as a result of which an error could result in the position determination of the strip.

The present invention, furthermore, is also directed toward a method for determining the position or presence of rolled or cast stock, especially of a metal strip or plate, which is moving through a casting, rolling, or other type of strip-processing facility, especially with a device or facility according to one of the above embodiments. According to the invention, the method comprises the steps of producing a liquid jet on one side of the path of movement of the rolled or cast stock and the detecting of the fluid jet on the other (opposite) side of the path of movement of the rolled or cast stock, so that the rolled or cast stock moving through the fluid jet interrupts the jet. In addition, the uninterrupted fluid let (i.e., the fluid jet in the absence of a strip) is guided into an air-filled cavity, wherein, when the jet is interrupted by rolled or cast stock moving through the jet, the air pressure in the air-filled cavity decreases, so that, on the basis of this decrease in air pressure (or change in air pressure), the presence of he roiled or cast stock is detected at the control or sync point.

The advantages of the method according to the invention correspond largely to those of the device or facility according to the invention.

In a preferred embodiment of the method, the fluid jet is generated underneath the path of movement of the rolled or cast stock and extends in an essentially vertical direction, wherein the air-filled cavity is arranged above the path of movement of the rolled or cast stock for detection of the fluid jet.

In a preferred embodiment of the method, the fluid jet is supplied in funnel-like fashion to the air-filled cavity.

In a preferred embodiment of the method, the fluid jet strikes the air-filled cavity as soon as the rolled or cast stock moves out of the way of the fluid jet (i.e., of the jet direction). Thus preferably the absence of the rolled or cast stock at the control or sync point is signaled.

All of the features of the embodiments described above can be combined with each other or possibly exchanged.

### SHORT DESCRIPTION OF THE FIGURES

The figures of the exemplary embodiments are described briefly in the following. Additional details are to be derived from the detailed description of the exemplary embodiments.

FIG. 1a shows a schematic side view of an exemplary embodiment of a device according to the invention for detecting the presence of moving rolled or cast stock at a control point, wherein the stock has not yet passed the control point;

FIG. 1b shows a schematic side view of an exemplary embodiment of a device according to the invention for detecting the presence of moving rolled or cast stock at control point, wherein the stock is just passing the control point; and

FIG. 1c shows a schematic side view of an exemplary embodiment of a device according to the invention for detecting the presence of moving rolled or cast stock at a control point, wherein the latter has passed the control point.

### DETAILED DESCRIPTION OF THE EXEMPLARY EMBODIMENTS

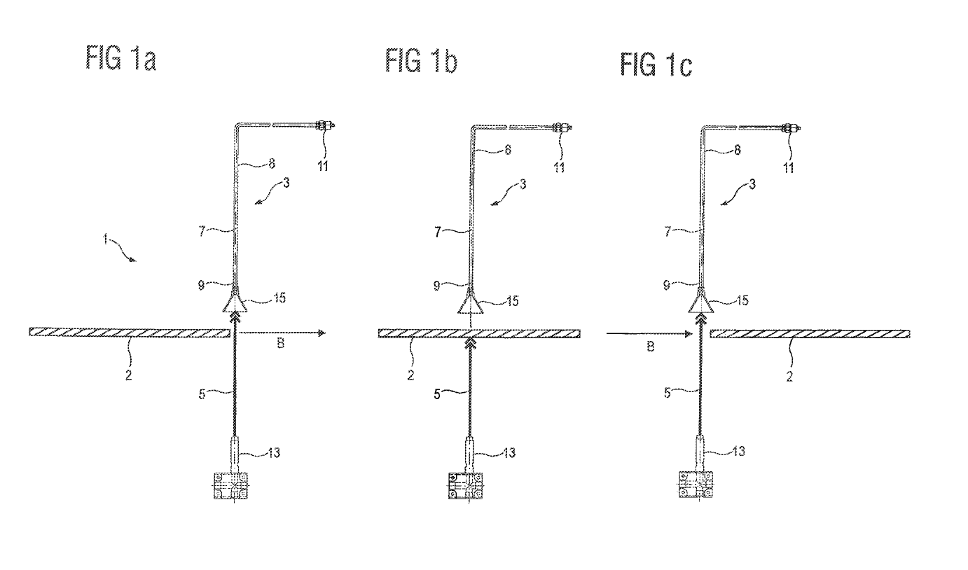

FIG. 1a shows an exemplary embodiment according to the invention of a device 1 for detecting a metal strip 2 or plate 2 in a strip-processing facility. The device 1 can be arranged at a control point or form such a control or synchronization point. As shown, a strip 2 is moving preferably in the direction B. The movement is not limited to one orientation, however. Reverse directions of the strip 2, such as those occurring in reversing mills, for example, are also possible. The strip 2 can also move along a curved or vertical path. For detection of the strip 2, preferably a fluid jet 5 is directed onto the (designated) path of movement of the strip 2. The fluid jet 5 can comprise gases, liquids, or mixtures thereof. The jet 5 is preferably produced by a nozzle 13, and as the jet travels vertically upward, it can strike the strip 2 passing the control point. Other orientations, however, are also possible.

The device 1 according to the invention also comprises a detection device 3, which for its own part can comprise a tube 8. This tube 8 preferably comprises, at the end directed toward the path of movement B of the strip 2, an opening 9. This opening can be oriented in particular so that, in the absence of the strip, the jet 5 produced by the nozzle 13 is conducted into the opening 9 or strikes this opening. The tube 8 can comprise any desired cross-sectional shape; it can be, for example, round, polygonal, or elliptical. A funnel 15 can be arranged. at the opening 9; this funnel helps the jet 5 enter the opening. It is not absolutely necessary, however, and merely simplifies the task of orienting the opening 9 of the tube 8 to the jet 5. A pressure sensor 11 is arranged at the end of the tube 8 or of the cavity 7 opposite the opening 9. This sensor can preferably configured as a pressure switch.

In general, the tube 8 can preferably be perpendicular to the direction of movement B of the metal strip 2, and the half of the tube facing away from the opening 9 can be bent. This makes it possible to prevent an object from reaching the pressure sensor 11 along a straight path.

FIG. 1b shows the same device as that of FIG. 1a. The same reference numbers are therefore used In contrast to the diagram of FIG. 1a, the fluid jet 5 is interrupted by the metal strip 2. The jet 5 therefore does not strike the opening 9 of the detection device 3. The pressure sensor can therefore report that the strip 2 is just now passing the control point or the device 1. According to FIG. 1a, the sensor is preferably reporting, in contrast, that the strip 2 has not passed the control point or the device. Between the situations shown in FIGS. 1a and 1b, the leading edge of the strip 2 (the forward edge of the strip relative to the direction of movement B) moves through the jet 5, as a result of which the passage of the metal strip 2 could be detected.

FIG. 1c shows the device 1, again with the use of the same reference numbers, wherein a situation is shown in which the metal strip shown in FIGS. 1a and 1b has passed the device 1 or the control point The strip 2 has therefore moved further onward in the direction of movement B, so that the jet 5 is now striking the detection device 3 again. Between the situations shown in FIGS. 1b and 1c, therefore, the trailing edge (the rear edge of the strip 2 relative to the direction of movement B) of the strip 2 has passed by the jet 5 or the device 1. The position of the trailing edge of the strip 2 is thus known as well. The decrease or increase in the pressure in the on the pressure sensor 11 caused by the jet 5 now again striking or conducted into the opening 9 signifies that the strip 2 has passed the device 1.

In general, a facility for conveying the strip 2 can comprise several rollers or rolls (not shown) Such rollers or rolls can be arranged on one or both (wide) sides of the strip 2. It is also possible for such rollers or rolls to be arranged in the stands of the facility,

The device 1 can in particular be arranged in a cooling section or cooling facility,

The above-described exemplary embodiments serve primarily to make it easier to understand the invention and are not to be understood as limiting.

The features of the exemplary embodiments described here and the objects of the summary of the invention can be combined with each other or exchanged for each other.

In addition, the described features can be adapted by the person skilled in the art to existing conditions or to current requirements.

### LIST OF REFERENCE SYMBOLS

1 device for detecting the presence of roiled or cast stock

2 rolled or cast stock

3 detection device

5 fluid jet

7 cavity

8 tube

9 tubular opening

11 air pressure sensor

13 means for producing a fluid jet

15 funnel-shaped component

B path of movement/direction of movement of the rolled or cast stock

1-15. (canceled)

16. A device for detecting the presence of rolled or cast stock in a casting, rolling, or other type of strip-processing facility, wherein the device comprises:
a detection device for detecting a fluid jet indicative of the presence of the rolled or cast stock, wherein the detection device comprises the following:
an air-filled cavity, which comprises a tubular opening; and
a pressure sensor for detecting a change in air pressure in the cavity as a function of arrival of a fluid jet at the tubular opening.

17. The device according to claim 16, wherein the detection device comprises a funnel-shaped component, located outside the cavity at the opening, to conduct the fluid jet into the opening.

18. The device according to claim 16, wherein the cavity comprises at least one tubular section that extends at least 1 m.

19. The device according to claim 18, wherein the tubular section extends at least 2 m.

20. The device according to claim 16, wherein the cavity is substantially formed by a tube.

21. The device according to claim 20, wherein the pressure sensor is arranged at an end of the tube opposite the opening.

22. The device according to claim 16, wherein the pressure sensor is a pressure switch.

23. The device according to claim 16, further comprising means for producing the fluid jet directed at the opening of the detection device.

24. The device according to claim 23, wherein the means for producing the fluid jet and the detection device are arranged on opposite sides of a path of movement of the rolled or cast stock, so that the air pressure in the cavity is decreased when the rolled or cast stock interrupts the fluid jet produced by the means for producing the fluid jet.

25. A facility for the casting, rolling, straightening, cooling, and/or conveying of rolled or cast stock, wherein the facility comprises:
a device according to claim ; and
equipment for conveying the rolled or cast stock, the equipment comprising several rollers or rolls for conveying the rolled or cast stock along a path of movement.

26. The facility according to claim 25, wherein the equipment conveys the rolled or cast stock in a substantially horizontal direction

27. The facility according to claim 25, wherein the detection device is arranged above the path of movement of the rolled or cast stock, and further comprising means for producing the directed fluid jet, the jet producing means being arranged underneath the path of movement of the rolled or cast stock.

28. A method for determining a position of rolled or cast stock at a control point, which stock is moving through a casting, rolling, or other type of strip-processing facility, wherein the method comprises the steps of:
producing a fluid jet on one side of a path of movement of the rolled or cast stock;
detecting the fluid jet on the other side of the path of movement of the rolled or cast stock, so that rolled or cast stock moving through the fluid jet interrupts the fluid jet, wherein the fluid jet, in the absence of the rolled or cast stock, is conducted into an air-filled cavity for detection; and
upon interruption of the fluid jet by the rolled or cast stock moving through the let, air pressure in the air-filled cavity decreases, so that, based on the decrease in air pressure, the presence of the rolled or cast stock is detected.

29. The method according to claim 28, wherein the fluid jet is produced underneath the path of movement of the rolled or cast stock in such a way that the fluid jet extends in substantially vertical direction, and wherein the air-filled cavity is arranged above the path of movement of the rolled or cast stock for detection of the fluid jet.

30. The method according to claim 28, wherein the fluid jet is conducted in funnel-like manner to the air-filled cavity.

31. The method according to claim 28, wherein, when the rolled or cast stock moves out of the way of the fluid jet, the fluid jet strikes the air-filled cavity and thereby signals the absence of the rolled or cast stock.
